(19) United States
(12) Patent Application Publication
(10) Pub. No.: US 2003/0180648 A1
(43) Pub. Date: Sep. 25, 2003

(54) Toner processes

(75) Inventors: Raj D. Patel, Oakville (CA); Michael A. Hopper, Toronto (CA); Vladislav Skorokhod, Mississauga (CA); Richard P. N. Veregin, Mississauga (CA); Michael S. Hawkins, Cambridge (CA); Paul j. Gerroir, Oakville (CA)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/106,473

(22) Filed: Mar. 25, 2002

(51) Int. Cl. C08J 3/215; G03G 9/083

(52) U.S. Cl. 430/137.14; 523/335

(57) ABSTRACT

A process which involves the heating of a magnetite dispersion, a colorant dispersion, a latex emulsion, and a coagulant, wherein the coagulant can be a polymetal halide, and the mixture is aggregated by heating below the latex resin glass transition temperature, and thereafter heating above the latex resin glass transition temperature, followed by cooling and isolating the product, which product can be a toner.

### RELATED APPLICATIONS

Illustrated in copending application U.S. Ser. No. ______ (not yet assigned—D/A1380) on Toner Processes, the disclosure of which is totally incorporated herein by reference, is a process comprising heating a latex, a colorant dispersion, a polytetrafluoroethylene dispersion, and an organo metallic complexing component.

Illustrated in copending application U.S. Ser. No. ______ (not yet assigned—D/A0662) on Toner Coagulant Processes, the disclosure of which is totally incorporated herein by reference, is a process for the preparation of toner comprising

(i) generating or providing a latex emulsion containing resin, water, and an ionic surfactant, and generating or providing a colorant dispersion containing colorant, water, and an ionic surfactant, or a nonionic surfactant;

(ii) blending the latex emulsion with the colorant dispersion;

(iii) adding to the resulting blend a coagulant of a polyamine salt of an acid wherein the salt is of an opposite charge polarity to that of the surfactant latex;

(iv) heating the resulting mixture below or about equal to the glass transition temperature (Tg) of the latex resin;

(v) optionally adding a second latex comprised of resin particles suspended in an aqueous phase resulting in a shell;

(vi) adjusting with a base the pH to about 7 to about 9;

(vii) heating the resulting mixture of (vi) above about the Tg of the latex resin;

(viii) retaining the heating until the fusion or coalescence of resin and colorant is initiated;

(ix) changing the pH of the above (viii) mixture with an acid to arrive at a pH of about 1.5 to about 3.5 to thereby accelerate the fusion or the coalescence and resulting in toner particles comprised of resin, and colorant; and

(x) optionally isolating the toner.

Illustrated in copending application U.S. Ser. No. ______ (not yet assigned—D/A1533) on Toner Processes, the disclosure of which is totally incorporated herein by reference, is a process for the preparation of a magnetic toner comprising heating a colorant dispersion containing acicular magnetite, a carbon black dispersion, a latex emulsion, and a wax dispersion.

Illustrated in copending application U.S. Ser. No. ______ (not yet assigned—D/A533Q) on Toner Processes, the disclosure of which is totally incorporated herein by reference, is a process for the preparation of a magnetic toner comprising the heating of a colorant dispersion comprised of a magnetite dispersion, and a carbon black dispersion, and thereafter mixing with a basic cationic latex emulsion and a wax dispersion.

Illustrated in copending application U.S. Ser. No. 10/062,129, filed Feb. 4, 2002 on Toner Processes, the disclosure of which is totally incorporated herein by reference, is a process comprising:

(i) providing or generating an emulsion latex comprised of sodio sulfonated polyester resin particles by heating said particles in water at a temperature of from about 65° C. to about 90° C.;

(ii) adding with shearing to said latex (i) a colorant dispersion comprising from about 20 percent to about 50 percent of a predispersed colorant in water, followed by the addition of an organic or an inorganic acid;

(iii) heating the resulting mixture at a temperature of from about 45° C. to about 65° C. followed by the addition of a water insoluble metal salt or a water insoluble metal oxide thereby releasing metal ions and permitting aggregation and coalescence, optionally resulting in toner particles of from about 2 to about 25 microns in volume average diameter; and optionally

(iv) cooling the mixture and isolating the product.

Illustrated in copending applications U.S. Ser. No. 09/877,747, filed Jun. 11, 2001 on Toner Coagulant Processes; U.S. Ser. No. 09/810,138, filed Mar. 19, 2001 on Toner Coagulant Processes; U.S. Ser. No. 09/922,263, filed Aug. 6, 2001 on Toner Coagulant Processes; U.S. Ser. No. 09/960,425, filed Sep. 24, 2001 on Toner Processes; and U.S. Ser. No. 09/976,943, filed Oct. 15, 2001 on Toner Coagulant Processes, the disclosures of which are totally incorporated herein by reference, are toner processes wherein a coagulant may be selected.

### BACKGROUND

This invention relates to toner processes, and more specifically, to aggregation and coalescence processes for the preparation of toner compositions containing magnetite. More specifically, the present invention relates in embodiments to methods for the preparation of toner compositions by a chemical process, such as emulsion aggregation wherein the latex particles are aggregated with colorants, such as magnetite in the presence of a coagulant, like a polymetal halide, or alternatively a mixture of coagulants, thereafter coalescing to provide toner size particles which when developed by an electrographic process generates documents suitable for magnetic image character recognition or MICR.

### REFERENCES

In U.S. Pat. No. 6,132,924, the disclosure of which is totally incorporated herein by reference, there is illustrated a process for the preparation of toner comprising mixing a colorant a latex, and a coagulant, followed by aggregation and coalescence, wherein the coagulant may be a polyaluminum chloride.

In U.S. Pat. No. 6,268,102, the disclosure of which is totally incorporated herein by reference, there is illustrated a process for the preparation of toner comprising mixing a colorant a latex, and a coagulant, followed by aggregation and coalescence, wherein the coagulant may be a poly aluminum sulfosilicate.

Illustrated in U.S. Pat. No. 5,994,020, the disclosure of which is totally incorporated herein by reference, are toner preparation processes, and more specifically, a process for the preparation of toner comprising

(i) preparing, or providing a colorant dispersion;

(ii) preparing, or providing a functionalized wax dispersion comprised of a functionalized wax contained in a dispersant mixture comprised of a nonionic surfactant, an ionic surfactant, or mixtures thereof;

(iii) shearing the resulting mixture of the functionalized wax dispersion (ii) and the colorant dispersion (i) with a latex or emulsion blend comprised of resin contained in a mixture of an anionic surfactant and a nonionic surfactant;

(iv) heating the resulting sheared blend of (iii) below about the glass transition temperature (Tg) of the resin particles;

(v) optionally adding additional anionic surfactant to the resulting aggregated suspension of (iv) to prevent, or minimize additional particle growth of the resulting electrostatically bound toner size aggregates during coalescence (iv);

(vi) heating the resulting mixture of (v) above about the Tg of the resin; and optionally,

(vii) separating the toner particles.

With respect to the above and other references, only a small part thereof has been selected and this part may or may not be fully representative of the prior art teachings or disclosures.

Magnetic ink printing methods with inks containing magnetic particles are known. For example, there is disclosed in U.S. Pat. No. 3,998,160, the disclosure of which is totally incorporated herein by reference, that various magnetic inks have been used in printing digits, characters, or artistic designs on checks or bank notes. The magnetic ink used for these processes can contain, for example, acicular magnetic particles, such as a magnetite in a fluid medium, and a magnetic coating of ferric oxide, chromium dioxide, or similar materials dispersed in a vehicle comprising binders, and plasticizers. According to the disclosure of the '160 patent, there is provided a method of printing on a surface with an ink containing acicular magnetic particles in order that the authenticity of the printing can be verified, and wherein a pattern is formed on a carrier with the ink in the wet state, and wherein the particles are subjected to a magnetic aligning process while the ink is on the carrier. Subsequently, the wet ink is transferred to the surface, which transfer is accomplished with substantially aligned particles.

Disclosed in U.S. Pat. No. 4,128,202, the disclosure of which is totally incorporated herein by reference, is a device for transporting a document that has been mutilated or erroneously encoded and wherein there is provided a predetermined area for the receipt of correctly encoded magnetic image character recognition information (MICR). As indicated in this patent, the information involved is referred to as MICR characters, which characters can appear, for example, at the bottom of personal checks as printed numbers and symbols. These checks have been printed in an ink containing magnetizable particles therein, and when the information contained on the document is to be read, the document is passed through a sorter/reader which first magnetizes the magnetizable particles, and subsequently detects a magnetic field of the symbols resulting from the magnetic retentivity of the ink. The characters and symbols involved, according to the '202 patent, are generally segregated into three separate fields, the first field being termed a transient field, which contains the appropriate symbols and characters to identify the bank, bank branch, or the issuing source.

In U.S. Pat. No. 5,914,209, the disclosure of which is totally incorporated by reference, there is illustrated a process for preparing MICR toners using a combination of hard and soft magnetites, and lubricating wax and melt mixing with a resin followed by jetting and classifying the blend to provide toner compositions.

In U.S. Pat. No. 4,517,268, the disclosure of which is totally incorporated by reference, there is illustrated a process for preparing MICR toners using styrene copolymers, such as styrene butadiene, in the absence of a lubricating wax by melt mixing in a Banbury apparatus, followed by pulverizing the magnetite and the resin, followed by jetting and classifying to provide, for example, 10 to 12 micron toner size particles which when mixed with an additive package and a carrier provides a developer suitable for using in the Xerox Corporation 9700®.

Further patents relating to MICR processes are U.S. Pat. Nos. 4,859,550; 5,510,221; 5,034,298 all illustrating, for example, the generation of MICR toners by conventional means such as that described in U.S. Pat. No. 4,517,268.

In U.S. Pat. No. 5,780,190, the disclosure of which is totally incorporated herein by reference, there is disclosed an ionographic process which comprises the generation of a latent image comprised of characters; developing the image with an encapsulated magnetic toner comprised of a core comprised of a polymer and soft magnetite, and wherein the core is encapsulated within a polymeric shell; and subsequently providing the developed image with magnetic ink characters thereon to a reader/sorter device.

In applications requiring MICR capabilities, the toners selected usually contain magnetites having specific properties, an important one of which is a high enough level of remanence or retentivity. Retentivity is a measure of the magnetism left when the magnetite is removed from the magnetic field, i.e., the residual magnetism. Also of value are toners with a high enough retentivity, such that when the characters are read, the magnetites produce a signal strength of equal to greater than about 100 percent. The signal level can vary in proportion to the amount of toner deposited on the document being generated. The signal strength of a toner composition can be measured by using known devices, including the MICR-Mate 1, manufactured by Checkmate Electronics, Inc.

In forming toner compositions for use with reprographic or xerographic print devices, emulsion aggregation processes are known. For example, emulsion/aggregation/coalescing processes for the preparation of toners are illustrated in a number of Xerox patents, the disclosures of which are totally incorporated herein by reference, such as U.S. Pat. No. 5,290,654, U.S. Pat. No. 5,278,020, U.S. Pat. No. 5,308,734, U.S. Pat. No. 5,370,963, U.S. Pat. No. 5,344,738, U.S. Pat. No. 5,403,693, U.S. Pat. No. 5,418,108, U.S. Pat. No. 5,364,729, and U.S. Pat. No. 5,346,797; and also of interest may be U.S. Pat. Nos. 5,348,832; 5,405,728; 5,366,841; 5,496,676; 5,527,658; 5,585,215; 5,650,255; 5,650,256 and 5,501,935; 5,723,253; 5,744,520; 5,763,133; 5,766,818; 5,747,215; 5,827,633; 5,853,944; 5,804,349; 5,840,462; 5,869,215; 5,869,215; 5,863,698; 5,902,710; 5,910,387; 5,916,725; 5,919,595; 5,925,488 and 5,977,210. The components and processes of the Xerox patents can be selected for the present invention in embodiments thereof.

In addition, the following U.S. patents relate to emulsion aggregation toner processes, the disclosures of which is totally incorporated herein by reference.

U.S. Pat. No. 5,922,501 describes a process for the preparation of toner comprising blending an aqueous colorant dispersion and a latex resin emulsion, and which latex resin is generated from a dimeric acrylic acid, an oligomer acrylic acid, or mixtures thereof and a monomer; heating the resulting mixture at a temperature about equal, or below about the glass transition temperature (Tg) of the latex resin to form aggregates; heating the resulting aggregates at a temperature about equal to, or above about the Tg of the latex resin to effect coalescence and fusing of the aggregates; and optionally isolating the toner product, washing, and drying.

U.S. Pat. No. 5,945,245 describes a surfactant free process for the preparation of toner comprising heating a mixture of an emulsion latex, a colorant, and an organic complexing agent.

U.S. Pat. No. 5,482,812 describes a process for the preparation of toner compositions or toner particles comprising (i) providing an aqueous pigment dispersion comprised of a pigment, an ionic surfactant, and optionally a charge control agent; (ii) providing a wax dispersion comprised of wax, a dispersant comprised of nonionic surfactant, ionic surfactant or mixtures thereof; (iii) shearing a mixture of the wax dispersion and the pigment dispersion with a latex or emulsion blend comprised of resin, a counterionic surfactant with a charge polarity of opposite sign to that of the ionic surfactant and a nonionic surfactant; (iv) heating the above sheared blend below about the glass transition temperature (Tg) of the resin to form electrostatically bound toner size aggregates with a narrow particle size distribution; (v) adding additional ionic surfactant to the aggregated suspension of (iv) to ensure that no, or minimal additional particle growth of the electrostatically bound toner size aggregates occurs on further increasing the temperature to coalesce the aggregates into toner particles (vi); (vi) heating the mixture of (v) with bound aggregates above about or at the Tg of the resin; and optionally (vii) separating the toner particles from the aqueous slurry by filtration and thereafter optionally washing.

U.S. Pat. No. 5,622,806 describes a process for the preparation of toner compositions with controlled particle size comprising (i) preparing a pigment dispersion in water, which dispersion is comprised of a pigment, an ionic surfactant in amounts of from about 0.5 to about 10 percent by weight to water, and an optional charge control agent; (ii) shearing the pigment dispersion with a latex mixture comprised of a counterionic surfactant with a charge polarity of opposite sign to that of the ionic surfactant, a nonionic surfactant, and resin particles, thereby causing a flocculation or heterocoagulation of the formed particles of pigment, resin, and charge control agent; and (iii) stirring.

### SUMMARY

It is a feature of the present invention to provide a magnetite containing toner for Magnetic Ink Character Recognition processes by, for example, using specific magnetites that provide an acceptable readability signal by a check reader.

It is further another feature of the present invention to provide a MICR toner prepared by a chemical process, especially an emulsion aggregation process wherein the particle morphology can be tailored from, for example, a potato to spherical shape.

It is also a feature of the present invention to provide a MICR toner by emulsion aggregation process and enabling the incorporation of needle shape or acicular magnetite particles of about 450 nanometers to about 700 nanometers in size.

It is yet another feature of the present invention to provide a process that is capable of incorporating needle shape or acicular magnetite, which have a coercivity about 350 oersteds (Oe) which is about 2 to 3 times that of cubic or spherical magnetite, which have a coercivity of about 110 oersteds to provide an adequate magnetic signal, for example greater then 100 percent, where 100 percent is described as the nominal signal for readability by a check reader.

In another feature there resides the preparation of a MICR toner by emulsion aggregation processes wherein the amount of acicular magnetite loading is about 23 to about 30 weight percent of toner, and about 45 to about 65 weight percent for either cubic or spherical magnetite to provide an adequate magnetic signal for readability by a check reader.

Also, in another feature there is disclosed a process for preparing a magnetite dispersion comprised of acicular or cubic iron oxide w particles in water containing an anionic surfactant or an nonionic surfactant by either ball milling, attrition, polytroning or media milling resulting in iron oxide particle stabilized by the surfactant, and which dispersion is aggregated with latex particles and wax particles to obtain a MICR toner.

In another feature there is disclosed a process for preparing a MICR toner in which the magnetite dispersion comprising acicular iron oxide particles, water and an anionic or a nonionic surfactant in which the iron oxide particle often tends to settle due to the density differences can be redispersed by a stirring means, including homogenization to obtain a suitable pigment dispersion for the preparation of MICR toners.

### EMBODIMENTS

Process aspects disclosed relate to a toner process for the preparation of a toner comprising mixing a colorant dispersion comprising an acicular magnetite dispersion and a carbon black dispersion with a latex, a wax dispersion and a coagulant; a process wherein

(i) the acicular magnetite is contained in water, and an anionic surfactant, or a nonionic surfactant, and the carbon black is contained in water and an anionic surfactant, or a nonionic surfactant, and wherein the latex emulsion is comprised of an anionic surfactant, water and resin;

(ii) wherein the colorant dispersion is blended with the latex emulsion, and thereafter adding a wax dispersion comprised of submicron wax particles of from about 0.1 to about 0.5 micron in diameter by volume, which wax is dispersed in an anionic surfactant;

(iii) adding to the resulting blend a coagulant, and which coagulant is a polymetal halide to thereby initiate flocculation or aggregation of the resin latex, the magnetite, the carbon black, and the wax;

(iv) heating the resulting mixture below about the glass transition temperature (Tg) of the latex resin to form toner sized aggregates;

(v) adding to the formed toner aggregates a second latex comprised of resin suspended in an aqueous phase containing an ionic surfactant and water;

(vi) adding to the resulting mixture a base to thereby change the pH which is from about 2 to about 2.9 to arrive at a pH of from about 7 to about 8 for the resulting toner aggregate mixture;

(vii) heating the resulting aggregate suspension of (vi) above about the Tg of the latex resin of (i);

(viii) optionally retaining the mixture temperature at from about 70° C. to about 95° C. optionally for a period of about 10 to about 60 minutes, followed by a pH reduction with an acid to arrive at a pH of about 5 to about 6 to assist in permitting the fusion or coalescence of the toner aggregates;

(ix) further retaining the mixture temperature from about 85° C. to about 95° C. for an optional period of about 12 to about 20 hours to assist in permitting the fusion or coalescence of the toner aggregates and to obtain smooth particles;

(x) washing the resulting toner slurry; and

(xi) isolating the toner; a process wherein the colorant dispersion contains an anionic surfactant; a process wherein the carbon black dispersion comprises carbon black particles dispersed in water and an anionic surfactant; a process wherein the amount of acicular magnetite selected is from about 20 to about 35 percent by weight of toner, and the coagulant is a polymetal halide present in an amount about 0.02 to about 0.2 percent by weight of toner; a process wherein the amount of acicular magnetite selected is from about 23 to about 32 percent by weight of toner, and the amount of coagulant, which coagulant is a polymetal halide, is present in an amount of about 0.05 to about 0.13 percent by weight of toner; a process wherein the acicular magnetite utilized exhibits a coercivity of from about 250 to about 700 Oe; a process wherein the acicular magnetite possesses a coercivity of from about 250 to about 500 Oe, and a remanent magnetization (Br) of about 23 to about 39 emu/g, a saturation magnetization (Bm) of about 70 to about 90 emu/g; a process wherein the toner exhibits a magnetic signal of about 115 to about 150 percent of the nominal where the nominal is a signal strength of about 100 percent; a process wherein the toner possesses a minimum fix temperature (MFT) of about 170° C. to about 195° C.; a process wherein the toner hot offset temperature (HOT) is from about 210° C. to about 250° C.; a process wherein the magnetite dispersion is obtained by ball milling, attrition, polytroning or media milling with an anionic surfactant resulting in magnetite particles suspended in water containing the anionic surfactant; a process wherein the amount of the carbon black dispersion is from about 4 to about 8 percent by weight of toner; a process wherein the latex contains resin particles of from about 0.15 to about 0.3 micron in volume average diameter; a process wherein the magnetite size is from about 0.6 micron to about 0.1 micron in average volume diameter, and the carbon black size diameter is from about 0.01 to about 0.2 micron in average volume diameter; a process wherein the acid is nitric, sulfuric, hydrochloric, citric or acetic acid, and the coagulant is a polymetal halide; a process wherein the base is selected from the group consisting of sodium hydroxide, potassium hydroxide, and ammonium hydroxide, and wherein the coagulant is a polymetal halide; a process wherein there is added to the formed toner aggregates the second latex comprised of submicron resin particles suspended in an aqueous phase containing an anionic surfactant, and wherein the second latex is selected in an amount of from about 10 to about 40 percent by weight of the initial latex (i) to form a shell thereover on the formed aggregates, and which shell is of an optional thickness of about 0.2 to about 0.8 micron wherein the coagulant is a polymetal halide; a process wherein the added latex contains the same resin as the initial latex of (i), or wherein the added latex contains a dissimilar resin than that of the initial latex; a process wherein the pH of the mixture resulting in (vi) is increased from about 2 to about 2.6 to about 6.5 to about 7.5, and wherein the base functions primarily as a stabilizer for the aggregates during coalescence (vii), and no or minimal toner particle size increase results, and wherein the coagulant is a polymetal halide; a process wherein the temperature at which toner sized aggregates are formed controls the size of the aggregates, and wherein the final toner size is from about 3 to about 15 microns in volume average diameter; a process wherein the aggregation (iv) temperature is from about 45° C. to about 60° C., and wherein the coalescence or fusion temperature of (vii) and (viii) is from about 80° C. to about 95° C., and wherein the coagulant is a polymetal halide; a process wherein the time of coalescence or fusion is from about 12 to about 20 hours, and wherein the toner resulting possesses a smooth morphology; a process wherein the latex contains a resin or polymer selected from the group consisting of poly(styrene-alkyl acrylate), poly(styrene-1,3-diene), poly(styrene-alkyl methacrylate), poly(styrene-alkyl acrylate-acrylic acid), poly(styrene-1,3-diene-acrylic acid), poly(styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly(styrene-1,3-diene-acrylonitrile-acrylic acid), and poly(alkyl acrylate-acrylonitrile-acrylic acid), and wherein the coagulant is a polymetal halide; a process wherein the latex contains a resin selected from the group consisting of poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(m ethyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), and poly(styrene-butyl acrylate-acrylononitrile-acrylic acid); a process comprising the heating of a magnetite dispersion, a colorant dispersion, a latex emulsion, and a coagulant, wherein the coagulant is a polymetal halide, and wherein the mixture is aggregated by heating below the latex resin glass transition temperature, and thereafter heating above the latex resin glass transition temperature; a process wherein there is further included a polymetal silicate, and wherein the aggregate mixture is at a pH of from about 6.5 to about 7.5, and wherein the latex is comprised of resin, nonionic surfactant, ionic surfactant, and water, and wherein the coagulant is a polyaluminum chloride; a process wherein the coagulant is the polymetal halide polyaluminum chloride, and wherein the polymetal silicate is a polyaluminum sulfo silicate; a process wherein the coagulant is polymetal halide of a polyaluminum chloride, or a polyaluminum bromide, and there is further added to the mixture a second coagulant of a polyaluminum sulfosilicate, or a polyaluminum sulfate; a process wherein the wax is a polyethylene; a process wherein the wax is a polypropylene; a process wherein the acicular magnetite possesses a coercivity of about 250 to about 700 Oe, a particle size in the range of about 0.6 micron in length×0.1 micron in diameter; a magnetite with a coercivity of from about 250 to about 500 Oe, a remanent magnetization (Br) of about 23 to 39 emu/g, and a saturation magnetization (Bm) of about 70 to about 90 emu/g; a magnetite with a coercivity of about 345 Oe, a remanent magnetization (Br) of about 35 emu/g, and a saturation magnetization (Bm) of about 85 emu/g; a magnetite with a coercivity of about 370 Oe, a remanent magnetization (Br) of about 33 emu/g, and a saturation magnetization (Bm) of about 83 emu/g; a magnetite with a coercivity of about 270 Oe, a remanent magnetization (Br) of about 20 emu/g, and a saturation magnetization (Bm) of about 79 emu/g; a magnetite with a coercivity of from about 250 to about 400 Oe, a remanent magnetization (Br) of about 23 to about 55 emu/g, and a saturation magnetization (Bm) of about 70 to about 90 emu/g; and wherein the acicular magnetite selected is present in the toner in an amount of from about 10 to about 40 weight percent; a process wherein the acicular magnetite possesses a coercivity of about 250 to about 700 Oe, a remanent magnetization (Br) of about 20 to about 40 emu/g, and a saturation magnetization (Bm) of about 70 to about 90 emu/g; a process wherein the magnetite is present in an amount of from about 50 to about 75 weight percent; a process wherein the magnetite is present in an amount of from about 55 to about 65 weight percent; a process wherein the coagulant is a polyaluminum chloride, there is further included in the mixture a wax dispersion, and wherein the magnetite possesses an acicular shape; a process wherein the acicular magnetite possesses a coercivity of about 250 to about 700 Oe, a particle size in the range of about 0.6 micron in length x 0.1 micron in diameter; a magnetite with a coercivity of from about 250 to about 500 Oe, a remanent magnetization (Br) of about 23 to about 39 emu/g, and a saturation magnetization (Bm) of about 70 to about 90 emu/g; and wherein the wax is a polyethylene, a polypropylene, or alternatively mixtures thereof; a process comprising heating a mixture of an acicular shaped magnetite dispersion, a black colored dispersion, a latex, and a coagulant, and wherein the heating involves a first heating and subsequently a second heating, and which second heating is at a higher temperature than the first heating; a process for the preparation of a toner comprising mixing a colorant dispersion comprising an acicular magnetite dispersion, a carbon black dispersion with a latex emulsion, a wax dispersion and a coagulant of, for example, a polymetal halide; a process wherein

(i) the acicular magnetite is contained in water, and an anionic surfactant, or a nonionic surfactant, and the carbon black is contained in water and an anionic surfactant, or a nonionic surfactant and wherein the latex emulsion is comprised of an anionic surfactant, water and resin, or alternatively a mixture of resins;

(ii) wherein the colorant dispersion is blended with the latex emulsion, and thereafter adding a wax dispersion comprised of submicron wax particles of from about 0.1 to about 0.5 micron in diameter by volume, which wax is dispersed in an anionic surfactant;

(iii) adding to the resulting blend a polymetal halide coagulant to thereby initiate flocculation or aggregation of the resin latex, the colorant dispersions, and the wax;

(iv) heating the resulting mixture below about, or about equal to the glass transition temperature (Tg) of the latex resin to form toner sized aggregates;

(v) adding to the formed toner aggregates a second latex comprised of resin suspended in an aqueous phase containing an ionic surfactant and water;

(vi) adding to the resulting mixture a base to thereby change the pH, which is from about 2 to about 2.9, to arrive at a pH of from about 7 to about 8 for the resulting toner aggregate mixture;

(vii) heating the resulting aggregate suspension of (vi) above about the Tg of the latex resin of (i);

(viii) retaining the mixture temperature at from about 70° C. to about 95° C. optionally for a period of about 10 to about 60 minutes, followed by a pH reduction with an acid to arrive at a pH of about 5 to about 6 to assist in permitting the fusion or coalescence of the toner aggregates;

(ix) further retaining the mixture temperature from about 80° C. to about 95° C. for a period of about 12 to about 20 hours to assist in permitting the fusion or coalescence of the toner aggregates and to obtain smooth toner particles;

(x) washing the resulting toner slurry; and

(xi) isolating the toner; a process wherein the dispersion comprises carbon black particles dispersed in water and an anionic surfactant; a process wherein the amount of acicular magnetite present is from about 20 to about 35 percent by weight of toner and the amount of polymetal halide present is about 0.02 to about 0.2 percent by weight of toner; a process wherein the amount of acicular magnetite is from about 20 to about 30 percent by weight of toner and the amount of polymetal halide is about 0.05 to about 0.1 percent by weight of toner; a process wherein the acicular magnetite, which can be comprised of 21 percent FeO and 79 percent Fe₂O₃ is selected from the group consisting of B2510, B2540, B2550, HDM-S 7111 with a coercivity of from about 250 to about 500 Oe and a remanent magnetization (Br) of about 23 to about 39 emu/g, and a saturation magnetization (Bm) of about 70 to about 90 emu/g, all available from Magnox; MR-BL with a coercivity of about 340 Oe, a remanent magnetization (Br) of about 34 emu/g, and a saturation magnetization (Bm) of about 85 emu/g, all available from Titan Kogyo and Columbia Chemicals; MTA-740 with a coercivity of about 370 Oe, a remanent magnetization (Br) of about 30 emu/g, and a saturation magnetization (Bm) of about 83 emu/g and all available from Toda Kogyo Inc.; AC 5151 M with a coercivity of about 270 Oe, a remanent magnetization (Br) of about 20 emu/g, and a saturation magnetization (Bm) of about 79 emu/g, available from Bayer Corporation; MO8029, MO4232, MO4431 with a coercivity of from about 250 to about 400 Oe, a remanent magnetization (Br) of about 23 to 60 emu/g, and a saturation magnetization (Bm) of about 70 to about 90 emu/g, available from Elementis Inc.; wherein the toner exhibits a magnetic signal from about 115 to about 150 percent of the nominal signal where nominal signal is described as a signal strength of 100 percent; a process wherein the toner possesses a minimum fix temperature (MFT) of about 170° C. to about 195° C.; a process wherein the toner hot offset temperature (HOT) is about 210° C. to about 260° C.; a process wherein magnetite dispersion is obtained by ball milling, attrition, polytroning or media milling resulting in magnetite particles dispersed in water containing an anionic surfactant; a process wherein the amount of the carbon black dispersion is from about 4 to about 8 percent by weight of toner; a process wherein the latex resin particles are from about 0.15 to about 0.3 micron in volume average diameter; a process wherein the magnetite size is from about 0.6 micron to about 0.1 micron and the carbon black size is from about 0.01 to about 0.2 micron in average volume diameter; a process wherein the acid is nitric, sulfuric, hydrochloric, citric or acetic acid; a process wherein there is added to the formed toner aggregates a second latex comprised of submicron resin particles suspended in an aqueous phase containing an anionic surfactant, and wherein the second latex is selected in an amount of from about 10 to about 40 percent by weight of the initial latex (i) to form a shell thereover on the formed aggregates, and which shell is of a thickness of about 0.2 to about 0.8 micron; a process wherein the pH of the mixture resulting in (vi) is increased from about 2 to about 2.6 to about 6.5 to about 7.5, and wherein the base functions primarily as a stabilizer for the aggregates during coalescence (vii), and no or minimal toner particle size or GSD increases result; a process wherein the temperature at which toner sized aggregates are formed controls the size of the aggregates, and wherein the final toner size is from about 5 to about 12 microns in volume average diameter; a process wherein the aggregation (iv) temperature is from about 45° C. to about 65° C., and wherein the coalescence or fusion temperature of, for example, (vii) and (viii) is from about 85° C. to about 95° C.; a process wherein the time of coalescence or fusion is from about 10 to about 25 hours, and wherein the toner particles possess smooth morphology; a process wherein the latex contains a resin or polymer selected from the group consisting of poly(styrene-alkyl acrylate), poly(styrene-1,3-diene), poly(styrene-alkyl methacrylate), poly(styrene-alkyl acrylate-acrylic acid), poly(styrene-1,3-diene-acrylic acid), poly(styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly(styrene-1,3-diene-acrylonitrile-acrylic acid), and poly(alkyl acrylate-acrylonitrile-acrylic acid); a process wherein the latex contains a resin selected from the group consisting of poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), and poly(styrene-butyl acrylate-acrylononitrile-acrylic acid), know suitable polymers, and the like; a process comprising the mixing of a magnetite dispersion, a carbon black colorant dispersion, a latex emulsion, a wax dispersion, and a coagulant of a polymetal halide, and wherein the mixture is aggregated by heating below the latex resin glass transition temperature, and thereafter by heating above the latex resin glass transition temperature; a process wherein there is further included a polymetal silicate coagulant, or alternatively as a second coagulant, and wherein the aggregate mixture is at a pH of from about 6.5 to about 7.5, and wherein the latex is comprised of resin, nonionic surfactant, ionic surfactant, and water; a process wherein the polymetal halide is a polyaluminum chloride, or bromide, and wherein the polymetal silicate is a polyaluminum sulfo silicate; a process for the preparation of a toner comprising (i) forming a resin latex dispersion of a resin in an aqueous ionic surfactant solution; (ii) preparing a pigment dispersion in water and wherein the pigment is a acicular magnetite of a an iron oxide comprised of FeO and Fe₂O₃ dispersed in water and in an anionic surfactant dispersion and/or a nonionic surfactant, and adding an anionic dispersion of a carbon black pigment; (iii) blending the resin latex dispersion with the pigment dispersion, and additionally an anionic wax dispersion to form a resin-pigment blend; (iv) adding a counterionic coagulant in an aqueous solution to the resin-pigment blend, while continuously subjecting the mixture to high shear to induce a homogeneous gel of the resin-pigment blend; (v) heating the sheared gel at temperatures below the glass transition temperature (Tg) of the latex resin while continuously stirring to form aggregate particles; (vi) allowing stabilization of aggregate particle size, adding a latex comprised of the same latex formulation as that of (i), or optionally an anionic latex comprising a different formulation than that of (i); (vii) changing the pH of the mixture resulting to greater than a pH of 6.5 to about 7.5 to stabilize the particles to growth, (viii) heating the aggregate particles at temperatures above the Tg of the resin, followed by lowering the pH of the aggregate particles to about 5.5 and heating further for a period of about 12 to about 20 hours to form coalesced particles of a toner composition; and (ix) separating and drying the toner composition; toner compositions prepared by (i) forming a resin latex dispersion of a resin in an aqueous anionic surfactant solution from a latex utilizing an anionic surfactant; (ii) preparing a pigment dispersion of an acicular magnetite pigment dispersed in water and an anionic dispersant, adding an anionic pigment dispersion of carbon black; (iii) blending about 70 to about 99 percent by weight of a total amount of the resin latex dispersion with the pigment dispersion, an anionic wax dispersion comprised of wax particle in suspended in water in the presence of an anionic surfactant to form a resin magnetite-carbon black/wax blend; (iv) adding a portion of a counterionic coagulant in an aqueous solution to the resin-pigment blend, while continuously subjecting the mixture to high shear, to induce a homogeneous gel of the resin-pigments blend; (v) heating the sheared gel at temperatures below a glass transition temperature (Tg) of the resin while continuously stirring to form aggregate particles; (vi) following a period of time, for example, such as about 10 minutes to about 65 minutes to permit stabilization of aggregate particle size; (vii) adding a remaining portion of the total amount of resin latex dispersion to be added in the process; (vii) change the pH of the slurry to greater than a pH 7 to stabilize the particles to growth, (viii) then heating the aggregate particles at temperatures above the Tg of the resin, followed by reducing the pH to about 5.5 in stages over a period of, for example, about 60 to about 90 minutes and further heating the mixture for a period of about 12 to about 20 hours to form coalesced particles of a toner composition; and (ix) separating and drying the toner composition; a process comprising the mixing colorant dispersions of acicular magnetite and carbon black with a latex emulsion, a wax dispersion, and a coagulant comprising of, for example, a polymetal halide, a polymetal silicate or mixtures thereof; wherein the colorant dispersion is comprised of

(i) acicular magnetite, water, and an anionic surfactant, and carbon black, water and an anionic surfactant, and wherein the latex is an emulsion comprised of an anionic surfactant, water and resin;

(ii) wherein the colorant dispersion is blended with the latex emulsion, and thereafter adding a wax dispersion comprised of submicron wax particles of from about 0.1 to about 0.7 micron in diameter by volume, which wax is dispersed in an anionic surfactant;

(iii) adding to the resulting blend a polyaluminum chloride or a polyaluminum sulfosilicate to thereby initiate flocculation or aggregation of the resin latex, the colorants, and the wax when present;

(iv) heating the resulting mixture below about the glass transition temperature (Tg) of the latex resin to form toner sized aggregates;

(v) adding to the formed toner aggregates a second latex comprised of resin suspended in an aqueous phase containing an ionic surfactant and water;

(vi) adding to the resulting mixture a base to thereby change the pH which is from about 2 to about 3 to arrive at a pH of from about 7 to about 8 for the resulting toner aggregate mixture;

(vii) heating the resulting aggregate suspension of (vi) above about the Tg of the latex resin of (i), while maintaining the pH at a value of about 7.5;

(viii) retaining the mixture temperature at from about 85° C. to about 95° C. optionally for a period of about 10 to about 60 minutes, followed by a pH reduction with an acid to arrive at a pH of about 5.5;

(ix) further retaining the mixture temperature from about 85° C. to about 95° C. for a period of about 12 to about 20 hours to assist in permitting the fusion or coalescence of the toner aggregates to obtain smooth particles;

(x) washing the resulting toner slurry; and

(xi) isolating the toner; and a process for preparing a chemical toner, wherein the blending and aggregation are performed at a pH of about 2 to about 3 or about 2 to about 2.8, while the coalescence is initially conducted at a pH of about 6.5 to about 8 followed by a reduction in pH to about 5.5 to about 6.5, and followed by further heating for a period of hours, for example, about 12 to about 15 hours; and a process for preparing a MICR toner composition by emulsion aggregation process, which toner possesses a smooth shape and feel, and contains from about 30 to about 50 weight percent of an acicular magnetite with a toner particle size distribution in the range of about 1.20 to about 1.26, and providing a MICR signal in the range of about 115 to about 130 percent and a bulk remanence of about 26 emu/gram wherein the remanence can be measured on a tapped powder magnetite sample in a cell of 1 centimeter×1 centimeter× about 4 centimeters. The sample is magnetized between two magnetic pole faces with a saturating magnetic field of 2,000 Gauss, such that the induced magnetic field is perpendicular to one of the 1×4 centimeter faces of the cell. The sample is removed from the saturating magnetic field, and the remanence is measured perpendicular to the above 1 centimeter wide face using a Hall-Effect device or a gaussmeter, such as the F. W. Bell, Inc. Model 615 gaussmeter.

Illustrative examples of resin particles selected for the process of the present invention include known polymers selected from the group consisting of poly(styrene-butadiene), poly(para-methyl styrene-butadiene), poly(meta-methyl styrene-butadiene), poly(alpha-methyl styrene-butadiene), poly(methylmethacrylate-butadiene), poly(ethylmethacrylate-butadiene), poly(propylmethacrylate-butadiene), poly(butylmethacrylate-butadiene), poly(methylacrylate-butadiene), poly(ethylacrylate-butadiene), poly(propylacrylate-butadiene), poly(butylacrylate-butadiene), poly(styrene-isoprene), poly(para-methyl styrene-isoprene), poly(meta-methyl styrene-isoprene), poly(alpha-methylstyrene-isoprene), poly(methylmethacrylate-isoprene), poly(ethylmethacrylate-isoprene), poly(propylmethacrylate-isoprene), poly(butylmethacrylate-isoprene), poly(methylacrylate-isoprene), poly(ethylacrylate-isoprene), poly(propylacrylate-isoprene), and poly(butylacrylate-isoprene); and terpolymers such as poly(styrene-butadiene-acrylic acid), poly(styrene-butadiene-methacrylic acid), PLIOTONE™ available from Goodyear, polyethylene-terephthalate, polypropylene-terephthalate, polybutylene-terephthalate, polypentylene-terephthalate, polyhexalene-terephthalate, polyheptadene-terephthalate, polyoctalene-terephthalate, POLYLITE™ (Reichhold Chemical Inc.), PLASTHALL (Rohm & Haas), CYGAL™ (American Cyanamide), ARMCO™ (Armco Composites), ARPOL™ (Ashland Chemical), CELANEX™ (Celanese Eng), RYNITE™ (DuPont), and STYPOL™.

The resin particles selected, which generally can be in embodiments, styrene acrylates, styrene butadienes, styrene methacrylates, or polyesters are present in various effective amounts, such as from about 70 weight percent to about 98 weight percent, and more specifically, between about 80 and about 92 percent of the toner, and which toner can be of small average particle size, such as from about 0.01 micron to about 1 micron in average volume diameter as measured by the Brookhaven nanosize particle analyzer. Other effective amounts of resin can be selected.

The resin particles selected for the process of the present invention can be prepared by, for example, emulsion polymerization techniques, including semicontinuous emulsion polymerization methods, and the monomers utilized in such processes can be selected from, for example, styrene, acrylates, methacrylates, butadiene, isoprene, and optionally acid or basic olefinic monomers, such as acrylic acid, methacrylic acid, acrylamide, methacrylamide, quaternary ammonium halide of dialkyl or trialkyl acrylamides or methacrylamide, vinylpyridine, vinylpyrrolidone, vinyl-N-methylpyridinium chloride and the like. The presence of acid or basic groups in the monomer or polymer resin is optional, and such groups can be present in various amounts of from about 0.1 to about 10 percent by weight of the polymer resin. Chain transfer agents, such as dodecanethiol or carbon tetrabromide, can also be selected when preparing resin particles by emulsion polymerization. Other processes of obtaining resin particles of, for example, from about 0.01 micron to about 1 micron can be selected from polymer microsuspension process, such as those illustrated in U.S. Pat. No. 3,674,736, the disclosure of which is totally incorporated herein by reference, polymer solution microsuspension process, such as disclosed in U.S. Pat. No. 5,290,654, the disclosure of which is totally incorporated herein by reference, mechanical grinding process, or other known processes.

Examples of anionic surfactants include, for example, sodium dodecylsulfate (SDS), sodium dodecylbenzene sulfonate, sodium dodecyinaphthalene sulfate, dialkyl benzenealkyl, sulfates and sulfonates, abitic acid, available from Aldrich, NEOGEN RK™, NEOGEN SC™ from Kao and the like. An effective concentration of the anionic surfactant generally employed is, for example, from about 0.01 to about 10 percent by weight, and preferably from about 0.1 to about 5 percent by weight of monomers used to prepare the toner polymer resin.

Examples of nonionic surfactants that may be, for example, included in the resin latex dispersion include, for example, polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxypoly(ethyleneoxy) ethanol, available from Rhodia as IGEPAL CA-210®, IGEPAL CA-520®, IGEPAL CA-720®, IGEPAL CO-890®, IGEPAL CO-720®, IGEPAL CO-290®, IGEPAL CA-210®, ANTAROX 890® and ANTAROX 897®. A suitable concentration of the nonionic surfactant is, for example, from about 0.01 to about 10 percent by weight, and preferably from about 0.1 to about 5 percent by weight of monomers used to prepare the toner polymer resin.

Examples of dispersants that can be suitable for dispersing the magnetite pigment particles can be functional copolymers, for example methyl vinyl ether-maleic acid, methyl vinyl ethermaleic acid calcium sodium salt, hydrophobically modified polyethers, polyvinylpyrrolidone homopolymers, alkylated vinylpyrrolidone copolymers, vinyl acetate/vinylpyrrolidone copolymers, vinylpyrrolidone/styrene block, poly(methyl vinyl ether/maleic anhydride) (linear interpolymer with 1:1 molar ratio), dimethylaminoethyl methacrylate, ethylene-vinyl acetate copolymer of maleic anhydride and acrylic acid, polystyrene-maleic anhydride, styrene-acrylic ester, ethyl acrylate/methyl methacrylate, carboxylated poly-n-butyl acrylates, and ethylene vinyl alcohol, and which, for example, permit the magnetite to be readily dispersible into a submicron particle size in the size range of, for example, about 30 to about 400 nanometers, in either an acid or a base resulting in a magnetite pigment that can be stabilized by resin particles.

The solids content of the resin latex dispersion is not particularly limited. The solids content may be from, for example, about 10 to about 90 percent. With regard to the pigment, such as carbon black, in some instances they are available in the wet cake or concentrated form containing water, and can be easily dispersed utilizing a homogenizer or simply by stirring or ball milling or attrition, or media milling. In other instances, pigments are available only in a dry form, whereby dispersion in water is effected by microfluidizing using, for example, a M-110 microfluidizer or an ultimizer, and passing the pigment dispersion from about 1 to about 10 times through a chamber by sonication, such as using a Branson 700 sonicator, with a homogenizer, ball milling, attrition, or media milling with the optional addition of dispersing agents such as the aforementioned ionic or nonionic surfactants.

Acicular magnetite examples are as illustrated herein such as those with a composition of about 21 percent FeO and about 79 percent Fe₂O₃ which usually possess a coercivity of about 250 to about 700 Oe with a particle size in the range of about 0.6 micron in length×0.1 micron in diameter; B2510, B2540, B2550, HDM-S 7111 whose coercivity is from about 250 to about 500 Oe, its remanent magnetization (Br) is about 23 to 39 emu/g, and its saturation magnetization (Bm) is about 70 to about 90 emu/g, available from Magnox Inc.; MR-BL whose coercivity is about 345 Oe with a remanent magnetization (Br) of about 35 emu/g, and a saturation magnetization (Bm) of about 85 emu/g, available from Titan Kogyo and Columbia Chemicals; MTA-740 whose coercivity is 370 Oe with a remanent magnetization (Br) of about 33 emu/g, and a saturation magnetization (Bm) of about 83 emu/g, available from Toda Kogyo Inc.; AC 5151M whose coercivity is 270 Oe with a remanent magnetization (Br) of about 20 emu/g, and a saturation magnetization (Bm) of about 79 emu/g, available from Bayer Corporation; and MO8029, MO4232, MO4431 whose coercivity is from about 250 to about 400 Oe with a remanent magnetization (Br) of about 23 to about 55 emu/g, and a saturation magnetization (Bm) of about 70 to about 90 emu/g, available from Elementis Inc. The acicular magnetite selected is present in the toner in the amount, for example, of from about 10 to about 35 weight percent, and more specifically, in the amount of about 22 to about 32 weight percent by weight of toner. In embodiments, cubic shaped magnetites may perhaps be selected.

Emulsion aggregation processes for the preparation of chemical toners include the utilization of an ionic coagulant having an opposite polarity to the ionic surfactant in the latex (i.e., a counterionic coagulant), typically cationic coagulant, to ensure that the latex containing the ionic surfactant, typically anionic surfactant, is fully aggregated into toner particles. The quantity of coagulant present to, for example, prevent/minimize the appearance of fines in the final slurry, i.e., fines refer to small sized particles of less than about 1 micron in average volume diameter, which fines can adversely affect toner yield.

Counterionic coagulants may be comprised of organic inorganic entities and the like. For example, in embodiments the ionic surfactant of the resin latex dispersion is an anionic surfactant, and the counterionic coagulant is a polymetal halide or a polymetal sulfo silicate (PASS).

Inorganic cationic coagulants include, for example, polyaluminum chloride (PAC), polyaluminum sulfo silicate (PASS), aluminum sulfate, zinc sulfate, or magnesium sulfate. The coagulant is in embodiments present in an aqueous medium in an amount of from, for example, about 0.05 to about 10 percent by weight, and more specifically, in an amount of from about 0.075 to about 2 percent by weight. The coagulant may also contain minor amounts of other components, for example nitric acid. The coagulant is usually added slowly into the blend while continuously subjecting the blend to high shear, for example by stirring with a blade at about 3,000 to about 10,000 rpm, most preferably about 5,000 rpm, for about 1 to about 120 minutes. A high shearing device, for example an intense homogenization device, such as the in-line IKA SD-41, may be used to ensure that the blend is homogeneous and uniformly dispersed.

Following homogenization, aggregation of the homogenized composition is effected by heating the composition to a temperature below the glass transition temperature (Tg) of the resin of the latex while agitating the composition. More specifically, the temperature of the heating is from, for example, about 5° C. to about 20° C. below the Tg of the resin. The agitating comprises continuously stirring the mixture using a mechanical stirrer set at between, for example, about 200 to about 800 rpm.

After aggregation, the resulting particles are coalesced by, for example, first changing the pH to about 6 to about 8, followed by heating at a temperature above the Tg of the latex resin in the toner particles. The heating for coalescing can in embodiments be conducted at a temperature of from about 10° C. to about 50° C., from about 25° C. to about 40° C., above the Tg of the resin for a suitable period, such as for example, about 30 minutes to about 10 hours.

During the coalescence, the pH is increased, for example, in the range of from about 2 to about 3 to about 6 to 8, from about 2 to about 2.8 to about 6.5 to 7.8 by the addition of a suitable pH increasing agent of, for example, sodium hydroxide. The increase in pH assists in stabilizing the aggregate particles and prevents/minimizes toner particle size growth and loss of GSD during further heat up, for example, raising the temperature about 10° C. to about 50° C. above the resin Tg. The reduction in pH during the coalescence for the fusion of the aggregates can be accomplished by using an acid. Examples of pH reducing agents include, for example, nitric acid, citric acid, sulfuric acid or hydrochloric acid, and the like.

In embodiments of the present invention, a multi-stage addition of latex is conducted. In particular, only a portion, for example about 20 to about 40 percent of the total amount of latex, is retained while the remainder is subjected to homogenization and aggregation. In these embodiments, a majority of the latex is added at the onset while the remainder of the latex (the delayed latex) is added after the formation of the resin/pigment aggregates. This delayed addition of the second or additional latex provides in embodiments an outer shell of non-pigmented material around the magnetite/pigmented core, thereby encapsulating the pigment in the core of the particles and away from the toner particle surface.

In embodiments, with the processes illustrated herein toner particles of acceptable size and narrow dispersity can be obtained in a more rapid method. The obtained toner particles possess, for example, an average volume diameter of from about 0.5 to about 25, and more specifically, from about 1 to about 10 microns, and narrow GSD characteristic of, for example, from about 1.05 to about 1.25, from about 1.15 to about 1.25 as measured by a Coulter Counter. The toner particles also have an excellent shape factor, for example, of 120 or less wherein the shape factor refers, for example, to the measure of toner smoothness and toner roundness, where a shape factor of about 100 is considered spherical and smooth without any surface protrusions, while a shape factor of about 145 is considered to be rough in surface morphology and the shape is like a potato.

The toner particles illustrated herein may also include known charge additives in effective amounts of, for example, from 0.1 to 5 weight percent such as alkyl pyridinium halides, bisulfates, the charge control additives of U.S. Pat. Nos. 3,944,493; 4,007,293; 4,079,014; 4,394,430 and 4,560,635, the disclosures of which are totally incorporated herein by reference, and the like. Surface additives that can be added to the toner compositions after washing or drying include, for example, metal salts, metal salts of fatty acids, colloidal silicas, metal oxides, mixtures thereof and the like, which additives are usually present in an amount of from about 0.1 to about 2 weight percent, reference U.S. Pat. Nos. 3,590,000; 3,720,617; 3,655,374 and 3,983,045, the disclosures of which are totally incorporated herein by reference. Specific additives include zinc stearate and AEROSIL R972® available from Degussa Chemical and present in an amount of from about 0.1 to about 2 percent which can be added during the aggregation process or blended into the formed toner product.

Developer compositions can be prepared by mixing the toners obtained with the process of the present invention with known carrier particles, including coated carriers, such as steel, ferrites, and the like, reference U.S. Pat. Nos. 4,937,166 and 4,935,326, the disclosures of which are totally incorporated herein by reference, for example from about 2 percent toner concentration to about 8 percent toner concentration.

The following Examples are provided. Parts and percentages are by weight unless otherwise indicated and temperatures are in degrees Centigrade.

### EXAMPLES

A latex emulsion (i) comprised of polymer particles generated from the emulsion polymerization of styrene, butyl acrylate and beta carboxy ethyl acrylate (Beta CEA) was prepared as follows. A surfactant solution of 434 grams of DOWFAX 2A1™ (anionic emulsifier) and 387 kilograms of deionized water was prepared by mixing for 10 minutes in a stainless steel holding tank. The holding tank was then purged with nitrogen for 5 minutes before transferring the mixture into a reactor. The reactor was then continuously purged with nitrogen while being stirred at 100 RPM. The reactor was then heated to 80° C.

Separately, 6.11 kilograms of ammonium persulfate initiator were dissolved in 30.2 kilograms of deionized water. Also, separately a monomer emulsion A was prepared in the following manner. 315.7 Kilograms of styrene, 91.66 kilograms of butyl acrylate, 12.21 kilograms of beta-CEA, 7.13 kilograms of 1-dodecanethiol, 1.42 kilograms of decanediol diacrylate (ADOD), 8.24 kilograms of DOWFAX™ (anionic surfactant), and 193 kilograms of deionized water were mixed to form an emulsion. Five percent of the above emulsion was then slowly fed into the reactor containing the aqueous surfactant phase at 80° C. to form the seeds wherein the “seeds” refer, for example, to the initial emulsion latex added to the reactor prior to the addition of the initiator solution, while being purged with nitrogen. The above initiator solution was then slowly charged into the reactor, forming about 5 to about 12 nanometers of latex “seed” particles. After 10 minutes, the remainder of the emulsion was continuously fed in using metering pumps.

Once all of the above monomer emulsion was charged into the main reactor, the temperature was maintained at 80° C. for an additional 2 hours to complete the reaction. The reactor contents were then cooled down to about 25° C. The resulting isolated product was comprised of 40 weight percent of submicron, 0.5 micron diameter resin particles of styrene/butylacrylate/betaCEA suspended in an aqueous phase containing the above surfactant. The molecular properties resulting for the resin latex were M_{w} of 39,000, Mₙ of 10.8, as measured by a Gel Permeation Chromatograph, and a midpoint Tg of 55.8° C., as measured by a Differential Scanning Calorimeter, where the midpoint Tg is defined as the halfway point between the onset and the offset Tg of the polymer.

Wax and Pigment Dispersions

The aqueous wax dispersion utilized in the following Examples was generated using (1) P725 polyethylene wax with a molecular weight M_{w} of 725, and a melting point of 104° C. or (2) P850 wax with a molecular weight of 850 and a melting point of 107° C. and NEOGEN RK™ as an anionic surfactant/dispersant. The waxes are available from Baker-Petrolite. The wax particle size was determined to be approximately 200 nanometers, and the wax slurry was supplied with a solid loading of 30 percent.

The pigment dispersion utilized was an aqueous dispersion of carbon black (REGAL 330®) pigment supplied from Sun Chemicals. The pigment dispersion contained an anionic surfactant and the pigment content of the dispersion supplied was 19 percent, 2 percent surfactant, and 79 percent water.

### Example I

(30 Percent Acicular Magnetite):

95 Grams of MAGNOX B2550™ acicular magnetite composed of 21 percent FeO and 79 percent Fe₂O₃, having a particle size of about 0.6 micron×0.1 micron were added to 300 grams of water containing 1.3 grams of 20 percent aqueous anionic surfactant (NEOGEN RK™) to which 83 grams of 18 percent carbon black solution were added and ball milled for a period of 3 hours. The resulting pigment dispersion was then aggregated with 330 grams of an anionic latex comprised of submicron latex particles (40 percent solids) of styrene/butylacrylate/beta CEA, and 90 grams of 200 nanometers in size of polyethylene P725 wax particles (30 percent solids), 68 percent water and 2 percent anionic surfactant, to which 3 grams of 10 percent by weight of solids of polyaluminum chloride (PAC) solution dissolved in nitric acid were added as a coagulant. The resulting blend was then heated to a temperature of 54° C. for a period of 400 minutes to obtain toner size aggregates of 5.8 microns in diameter. 130 Grams of the above latex was then added to the aggregate mixture and allowed to mix for about 30 minutes. The particle size obtained was 6.2 microns. This was followed by changing the pH of the mixture to a pH of 7.5 with an aqueous solution of 4 percent sodium hydroxide. The mixture resulting was then heated to 93° C. during which the pH was maintained at 7.5 with the addition of an aqueous 4 percent sodium hydroxide solution. After 5 hours at 93° C. the pH was reduced in stages (e.g. 6.5 to 5.5 to 5) with an aqueous 2.5 percent of nitric acid solution over a period of 1 hour. The resulting mixture was allowed to heat for an additional period of 10 hours resulting in particles with a smooth morphology with some protrusions and a particle size of 6.5 microns with a GSD of 1.23. The toner was washed 4 times with water and dried on a known freeze dryer. The toner product was comprised of 29.6 percent magnetite, 57.3 percent resin, 8.4 percent wax, and 4.7 percent carbon black. This toner provided a magnetic signal of 118 percent of nominal and the remanance measured was 25.5 emu/g. Toner images were developed at 300 volts, the operating voltage for the Xerox DC 265 printer giving a TMA of 0.72 cm/A, which in turn provides a MICR readability signal of about 118 satisfying a target specification of >115 percent and exceeding the U.S. and Canadian Banking Standards.

### Example II

(Repeat—30 Percent Acicular Maqnetite):

95 Grams of MAGNOX B2550™ acicular magnetite composed of 21 percent FeO and 79 percent Fe₂O₃, having a particle size of about 0.6 micron×0.1 micron were added in 300 grams of water containing 1.3 grams of 20 percent aqueous anionic surfactant (NEOGEN RK™) to which 83 grams of 18 percent carbon black solution were added and ball milled for a period of 3 hours. The resulting pigment dispersion was then aggregated with 330 grams of anionic latex comprised of submicron latex particles (40 percent solids) of styrene/butylacrylate/beta CEA, and 90 grams of 200 nanometers in size of polyethylene P725 wax particles (30 percent solids), 68 percent water and 2 percent anionic surfactant, to which 3 grams of 10 percent by weight of solids of polyaluminum chloride (PAC) solution dissolved in nitric acid were added as a coagulant. The resulting blend was then heated to a temperature of 54° C. for a period of 420 minutes to obtain toner aggregates of a size diameter of 6 microns. 130 Grams of the above latex were then added to the aggregate mixture and the resulting mixture was allowed to mix for about 30 minutes; the particle size obtained was 6.3 microns. This was followed by changing the pH of the mixture to a pH of 7.5 with an aqueous solution of 4 percent sodium hydroxide. The mixture was then heated to 93° C. during which the pH was maintained at 7.5 with the addition of an aqueous 4 percent sodium hydroxide solution. After 5 hours at 93° C., the pH was reduced in stages (e.g. 6.5 to 5.5 to 5) with an aqueous 2.5 percent of nitric acid solution over a period of 1 hour. The mixture resulting was allowed to heat for an additional period of 10 hours resulting in particles with a smooth morphology with some protrusions and a particle size of 6.6 microns with a GSD of 1.22. The toner was washed 4 times with water and dried on a freeze dryer. The toner was comprised of 29.6 percent magnetite, 57.3 percent resin, 8.4 percent wax, and 4.7 percent carbon black. The toner gave a magnetic signal of 120 percent of nominal and the remanance measured was 25.5 emu/g. Toner images were developed at 300 volts, the operating voltage for the Xerox DC 265 printer, giving a TMA of 0.72 cm/A, which in turn provided a MICR readability signal of about 120 percent, satisfying the target specification of >115 percent and exceeding the U.S. and Canadian Banking Standards.

### Example III

(30 Percent Acicular Maqnetite with P850, M_{w} 850, Wax):

95 Grams of MAGNOX B2550™ acicular magnetite composed of 21 percent FeO and 79 percent Fe₂O₃, having a particle size of about 0.6 micron×0.1 micron were added to 300 grams of water containing 1.3 grams of 20 percent aqueous anionic surfactant (NEOGEN RK™) to which 83 grams of 18 percent carbon black solution were added and ball milled for a period of 3 hours. The resulting pigment dispersion was then aggregated with 330 grams of an anionic latex comprised of submicron latex particles (40 percent solids) of styrene/butylacrylate/beta CEA, and 90 grams of 200 nanometers in size of polyethylene P850 wax particles (30 percent solids), 68 percent water and 2 percent anionic surfactant, to which 3 grams of 10 percent by weight of solids of polyaluminum chloride (PAC) solution dissolved in nitric acid were used as a coagulant. The resulting blend was then heated to a temperature of 54° C. for a period of 400 minutes to obtain toner aggregates of a size diameter of 6.3 microns. 130 Grams of the above latex were then added to the aggregate mixture and allowed to mix for about 30 minutes. The particle size obtained was 6.6 microns. This was followed by changing the pH of the mixture to a pH of 7.5 with an aqueous solution of 4 percent sodium hydroxide. The mixture was then heated to 93° C. during which the pH was maintained at 7.5 with the addition of an aqueous 4 percent sodium hydroxide solution. After 5 minutes at 93° C., the pH was reduced in stages (e.g. 6.5 to 5.5 to 5) over a period of 1 hour with an aqueous 2.5 percent of nitric acid solution. The mixture resulting was then allowed to heat for an additional period of 10 hours resulting in particles with a smooth morphology with some protrusions and a particle size of 6.8 microns with a GSD of 1.22. The toner product was washed 4 times with water and dried on a freeze dryer. The toner product was comprised of 29.6 percent magnetite, 57.3 percent resin, 8.4 percent wax, and 4.7 percent carbon black. The toner product provided a magnetic signal of 123 percent of nominal and the remanance was 25.5 emu/g. Toner images were developed at 300 volts, the operating voltage for the Xerox DC 265 printer, providing a TMA of 0.72 cm/A, which in turn provides a MICR readability signal of about 123, satisfying the target specification of 100 to 110 percent and exceeding the U.S. and Canadian Banking Standards.

### Example IV

(62 Percent Cubic Magnetite):

435 Grams of MAPICO BLACK™ cubic magnetite composed of 21 percent FeO and 79 percent Fe₂O₃ having a particle size of 0.1×0.1×0.1 micron were dispersed in 500 grams of water to which 2 grams of a 20 percent aqueous anionic surfactant (NEOGEN RK™) and 166 grams of (18 percent solids) carbon black solution were added and ball milled for a period of 3 hours. The resulting pigment dispersion was then aggregated with 330 grams of an anionic latex comprising submicron latex particles (40 percent solids) of styrene/butylacrylate/beta CEA, and 200 grams of a dispersion of 200 nanometers in size of polyethylene P725 wax particles (30 percent solids), 68 percent water and 2 percent anionic surfactant, to which 4 grams of 10 percent by weight of solids of polyaluminum chloride (PAC) solution dissolved in nitric acid were added as a coagulant. The resulting blend was then heated to a temperature of 53° C. to obtain toner size aggregates of 6 microns for a period of 200 minutes. 130 Grams of the above latex were then added to the aggregate mixture followed by changing the pH of the mixture to a pH of 7.5 with an aqueous solution of a 4 percent sodium hydroxide. The mixture was then heated to 93° C. during which the pH was maintained at 7.5 with the addition of aqueous 4 percent sodium hydroxide solution. After 2 hours at 93° C., the pH was reduced to 6.5 with an aqueous 2.5 percent of solution of nitric acid. The mixture was allowed to heat for an additional period of 30 minutes and particle size increased as well as the GSD. The toner was rough in shape. The resulting toner was comprised of 61.4 percent magnetite, 26 percent resin, 8.4 5 wax, and 4.2 percent carbon black, and provided a magnetic signal of 123 percent of nominal and a remanance of 43.4 emu/g. The morphology of the particles was very rough.

The loss in particle size and the widening of the GSD was explained by the alignment of the aggregate particles during the coalescence. This was generally believed to be the internal alignment of the magnetite particles themselves once the pigment loading was beyond a certain critical concentration in the aggregates. In other words, the aggregation step was not of an issue, but the problems of particle size control was a major problem during the coalescence step, especially in the later stages when the pH of the mixture was reduced to facilitate the flow of the resin. As the viscosity of the resin inside the aggregates decreased (i.e. begins to flow) the magnetite particles can diffuse inside the aggregates and align since there was sufficient concentration of the magnetite particle in comparison to the resin. As the heating was continuously applied to coalesce the aggregate particles, the aggregates themselves began to align with each other forming a chain. Hot aggregates in contact fused together and this was observed by the increase in the particle size and the broadening of the particle size distribution

Other embodiments and modifications of the present invention may occur to those skilled in the art subsequent to a review of the information presented herein; these embodiments and modifications, equivalents thereof, substantial equivalents thereof, or similar equivalents thereof are also included within the scope of this invention.

What is claimed is:

1. A toner process for the preparation of a toner comprising mixing a colorant dispersion comprising an acicular magnetite dispersion and a carbon black dispersion with a latex, a wax dispersion and a coagulant.

2. A process in accordance with claim 1 wherein
(i) said acicular magnetite is contained in water, and an anionic surfactant, or a nonionic surfactant, and said carbon black is contained in water and an anionic surfactant, or a nonionic surfactant, and wherein said latex emulsion is comprised of an anionic surfactant, water and resin;
(ii) wherein said colorant dispersion is blended with said latex emulsion, and thereafter adding a wax dispersion comprised of submicron wax particles of from about 0.1 to about 0.5 micron in diameter by volume, which wax is dispersed in an anionic surfactant;
(iii) adding to the resulting blend said coagulant, and which coagulant is a polymetal halide to thereby initiate flocculation or aggregation of said resin latex, said magnetite, said carbon black, and said wax;
(iv) heating the resulting mixture below about the glass transition temperature (Tg) of the latex resin to form toner sized aggregates;
(v) adding to the formed toner aggregates a second latex comprised of resin suspended in an aqueous phase containing an ionic surfactant and water;
(vi) adding to the resulting mixture a base to thereby change the pH which is from about 2 to about 2.9 to arrive at a pH of from about 7 to about 8 for the resulting toner aggregate mixture;
(vii) heating the resulting aggregate suspension of (vi) above about the Tg of the latex resin of (i);
(viii) optionally retaining the mixture temperature at from about 70° C. to about 95° C. optionally for a period of about 10 to about 60 minutes, followed by a pH reduction with an acid to arrive at a pH of about 5 to about 6 to assist in permitting the fusion or coalescence of the toner aggregates;
(ix) further retaining the mixture temperature from about 85° C. to about 95° C. for an optional period of about 12 to about 20 hours to assist in permitting the fusion or coalescence of the toner aggregates and to obtain smooth particles;
(x) washing the resulting toner slurry; and
(xi) isolating the toner.

3. A process in accordance with claim 1 wherein said colorant dispersion contains an anionic surfactant.

4. A process in accordance with claim 1 wherein said carbon black dispersion comprises carbon black particles dispersed in water and an anionic surfactant.

5. A process in accordance with claim 1 wherein the amount of acicular magnetite selected is from about 20 to about 35 percent by weight of toner, and the coagulant is a polymetal halide present in an amount about 0.02 to about 0.2 percent by weight of toner.

6. A process in accordance with claim 1 wherein the amount of acicular magnetite selected is from about 23 to about 32 percent by weight of toner, and the amount of coagulant, which coagulant is a polymetal halide, is present in an amount of about 0.05 to about 0.13 percent by weight of toner.

7. A process in accordance with claim 1 wherein the acicular magnetite utilized exhibits a coercivity of from about 250 to about 700 Oe.

8. A process in accordance with claim 1 wherein said acicular magnetite possesses a coercivity of from about 250 to about 500 Oe, and a remanent magnetization (Br) of about 23 to about 39 emu/g, a saturation magnetization (Bm) of about 70 to about 90 emu/g.

9. A process in accordance with claim 1 wherein the toner exhibits a magnetic signal of about 115 to about 150 percent of the nominal where the nominal is a signal strength of about 100 percent.

10. A process in accordance with claim 1 wherein the toner possesses a minimum fix temperature (MFT) of about 170° C. to about 195° C.

11. A process in accordance with claim 10 wherein the toner hot offset temperature (HOT) is from about 210° C. to about 250° C.

12. A process in accordance with claim 1 wherein the magnetite dispersion is obtained by ball milling, attrition, polytroning or media milling with an anionic surfactant resulting in magnetite particles suspended in water containing said anionic surfactant.

13. A process in accordance with claim 1 wherein the amount of said carbon black dispersion is from about 4 to about 8 percent by weight of toner.

14. A process in accordance with claim 1 wherein the latex contains resin particles of from about 0.15 to about 0.3 micron in volume average diameter.

15. A process in accordance with claim 1 wherein the magnetite size is from about 0.6 micron to about 0.1 micron in average volume diameter, and the carbon black size diameter is from about 0.01 to about 0.2 micron in average volume diameter.

16. A process in accordance with claim 2 wherein the said acid is nitric, sulfuric, hydrochloric, citric or acetic acid, and said coagulant is a polymetal halide.

17. A process in accordance with claim 2 wherein said base is selected from the group consisting of sodium hydroxide, potassium hydroxide, and ammonium hydroxide, and wherein said coagulant is a polymetal halide.

18. A process in accordance with claim 2 wherein there is added to the formed toner aggregates said second latex comprised of submicron resin particles suspended in an aqueous phase containing an anionic surfactant, and wherein said second latex is selected in an amount of from about 10 to about 40 percent by weight of the initial latex (i) to form a shell thereover on said formed aggregates, and which shell is of an optional thickness of about 0.2 to about 0.8 micron wherein said coagulant is a polymetal halide.

19. A process in accordance with claim 18 wherein said added latex contains the same resin as the initial latex of (i), or wherein said added latex contains a dissimilar resin than that of the initial latex.

20. A process in accordance with claim 2 wherein the pH of the mixture resulting in (vi) is increased from about 2 to about 2.6 to about 6.5 to about 7.5, and wherein said base functions primarily as a stabilizer for the aggregates during coalescence (vii), and no or minimal toner particle size increase results, and wherein said coagulant is a polymetal halide.

21. A process in accordance with claim 2 wherein the temperature at which toner sized aggregates are formed controls the size of the aggregates, and wherein the final toner size is from about 3 to about 15 microns in volume average diameter.

22. A process in accordance with claim 2 wherein the aggregation (iv) temperature is from about 45° C. to about 60° C., and wherein the coalescence or fusion temperature of (vii) and (viii) is from about 80° C. to about 95° C., and wherein said coagulant is a polymetal halide.

23. A process in accordance with claim 2 wherein the time of coalescence or fusion is from about 12 to about 20 hours, and wherein the toner resulting possesses a smooth morphology.

24. A process in accordance with claim 1 wherein the latex contains a resin or polymer selected from the group consisting of poly(styrene-alkyl acrylate), poly(styrene-1,3-diene), poly(styrene-alkyl methacrylate), poly(styrene-alkyl acrylate-acrylic acid), poly(styrene-1,3-diene-acrylic acid), poly(styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly(styrene-1,3-diene-acrylonitrile-acrylic acid), and poly(alkyl acrylate-acrylonitrile-acrylic acid), and wherein said coagulant is a polymetal halide.

25. A process in accordance with claim 2 wherein the latex contains a resin selected from the group consisting of poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly (methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), and poly(styrene-butyl acrylate-acrylononitrile-acrylic acid).

26. A process comprising the heating of a magnetite dispersion, a colorant dispersion, a latex emulsion, and a coagulant, wherein said coagulant is a polymetal halide, and wherein said mixture is aggregated by heating below the latex resin glass transition temperature, and thereafter heating above the latex resin glass transition temperature.

27. A process in accordance with claim 26 wherein there is further included a polymetal silicate, and wherein said aggregate mixture is at a pH of from about 6.5 to about 7.5, and wherein said latex is comprised of resin, nonionic surfactant, ionic surfactant, and water, and wherein said coagulant is a polyaluminum chloride.

28. A process in accordance with claim 26 wherein said coagulant is the polymetal halide polyaluminum chloride, and wherein said polymetal silicate is a polyaluminum sulfo silicate.

29. A process in accordance with claim 1 wherein said coagulant is polymetal halide of a polyaluminum chloride, or a polyaluminum bromide, and there is further added to the mixture a second coagulant of a polyaluminum sulfosilicate, or a polyaluminum sulfate.

30. A process in accordance with claim 1 wherein said wax is a polyethylene.

31. A process in accordance with claim 1 wherein said wax is a polypropylene.

32. A process in accordance with claim 1 wherein said acicular magnetite possesses a coercivity of about 250 to about 700 Oe, a particle size in the range of about 0.6 micron in length×0.1 micron in diameter; a magnetite with a coercivity of from about 250 to about 500 Oe, a remanent magnetization (Br) of about 23 to 39 emu/g, and a saturation magnetization (Bm) of about 70 to about 90 emu/g; a magnetite with a coercivity of about 345 Oe, a remanent magnetization (Br) of about 35 emu/g, and a saturation magnetization (Bm) of about 85 emu/g; a magnetite with a coercivity of about 370 Oe, a remanent magnetization (Br) of about 33 emu/g, and a saturation magnetization (Bm) of about 83 emu/g; a magnetite with a coercivity of about 270 Oe, a remanent magnetization (Br) of about 20 emu/g, and a saturation magnetization (Bm) of about 79 emu/g; a magnetite with a coercivity of from about 250 to about 400 Oe, a remanent magnetization (Br) of about 23 to about 55 emu/g, and a saturation magnetization (Bm) of about 70 to about 90 emu/g; and wherein said acicular magnetite selected is present in the toner in an amount of from about 10 to about 40 weight percent.

33. A process in accordance with claim 1 wherein said acicular magnetite possesses a coercivity of about 250 to about 700 Oe, a remanent magnetization (Br) of about 20 to about 40 emu/g, and a saturation magnetization (Bm) of about 70 to about 90 emu/g.

34. A process in accordance with claim 26 wherein said magnetite is present in an amount of from about 50 to about 75 weight percent.

35. A process in accordance with claim 26 wherein said magnetite is present in an amount of from about 55 to about 65 weight percent.

36. A process in accordance with claim 26 wherein said coagulant is a polyaluminum chloride, there is further included in said mixture a wax dispersion, and wherein said magnetite possesses an acicular shape.

37. A process in accordance with claim 1 wherein said acicular magnetite possesses a coercivity of about 250 to about 700 Oe, a particle size in the range of about 0.6 micron in length×0.1 micron in diameter; a magnetite with a coercivity of from about 250 to about 500 Oe, a remanent magnetization (Br) of about 23 to about 39 emu/g, and a saturation magnetization (Bm) of about 70 to about 90 emu/g; and wherein said wax is a polyethylene, a polypropylene, or alternatively mixtures thereof.

38. A process comprising heating a mixture of an acicular shaped magnetite dispersion, a black colored dispersion, a latex, and a coagulant, and wherein said heating involves a first heating and subsequently a second heating, and which second heating is at a higher temperature than said first heating.
